(19) United States
(12) Patent Application Publication
(10) Pub. No.: US 2025/0180788 A1
(43) Pub. Date: Jun. 5, 2025

(54) LENS, LENS GROUP, METHOD FOR ADJUSTING DIOPTER OF LENS GROUP, AND HEAD MOUNTED DISPLAY DEVICE

(71) Applicants: Asphetek Solution (Chengdu) Ltd., Chengdu (CN); ADVANCED OPTOELECTRONIC TECHNOLOGY, INC., Hsinchu County (TW); Asphetek Solution Inc., Hsinchu (TW)

(72) Inventors: YUAN-TING LIANG, Hsinchu (TW); CHUNG-WU LIU, Hsinchu (TW)

(21) Appl. No.: 18/594,160

(22) Filed: Mar. 4, 2024

(30) Foreign Application Priority Data
Nov. 30, 2023 (CN) 202311640743.0

(51) Int. Cl. G02B 3/00; F21V 8/00; G02B 7/02; G02B 7/14; G02B 27/01; G02C 7/02

(52) U.S. Cl. CPC G02B 3/0081; G02B 6/0036; G02B 7/025; G02B 7/14; G02B 27/0172; G02C 7/027

(57) ABSTRACT

A lens includes a housing and a second medium. The housing is made of a first medium. The housing defines a cavity. The second medium fills in the cavity. The second medium has a required refractive index. The second medium is replaceable in the cavity. A lens group including the lens, a head mounted display device including the lens group, and a method for adjusting a refractive index of the lens group are also provided.

### FIELD

The subject matter herein relates to a field of near eye display, particularly relates to a lens, a lens group including the lens, a method for adjusting a diopter of the lens group, and a head mounted display device including the lens group.

### BACKGROUND

Virtual Reality (VR), augmented Reality (AR), and mixed Reality (MR) technologies are widely applied to entertainment electronic products. However, as users having myopia/hyperopia increases, it is necessary to install different degrees of myopia/hyperopia lenses on different head mounted display devices. Myopia/hyperopia lenses can have different curvatures and thicknesses depending on refractive index of a substrate of the myopia/hyperopia lenses. Lenses having a high refractive index substrate have a less thickness and a less curvature, so the myopia/hyperopia lenses of different users are different. When fitting various optical components during actual production, due to differences of myopia/hyperopia lenses among different users, it is often necessary to adjust different parameters of the fitting equipment during the fitting process, which reduces efficiency of actual production.

Therefore, there is room for improvement in the art.

### BRIEF DESCRIPTION OF THE DRAWINGS

Implementations of the present technology will now be described, by way of embodiments only, with reference to the attached figures.

FIG. 1 is a schematic view of a lens according to a first embodiment of the present disclosure.

FIG. 2 is a schematic view of a lens according to a second embodiment of the present disclosure.

FIG. 3 is a schematic view of a lens according to a third embodiment of the present disclosure.

FIG. 4 is a schematic view of a lens according to a fourth embodiment of the present disclosure.

FIG. 5 is a schematic view of a lens group according to an embodiment of the present disclosure.

FIG. 6 is a schematic view of a head mounted display device according to an embodiment of the present disclosure.

FIG. 7 is a schematic view of a head mounted display device according to another embodiment of the present disclosure.

FIG. 8 is a flow chart of an embodiment of processes to adjust refractive index of a lens group according to the present application.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as coupled, whether directly or indirectly through intervening components, and is not necessarily limited to physical connections. The connection can be such that the objects are permanently coupled or releasably coupled. The term “comprising” when utilized, means “including, but not necessarily limited to”; it specifically indicates open-ended inclusion or membership in the so-described combination, group, series, and the like.

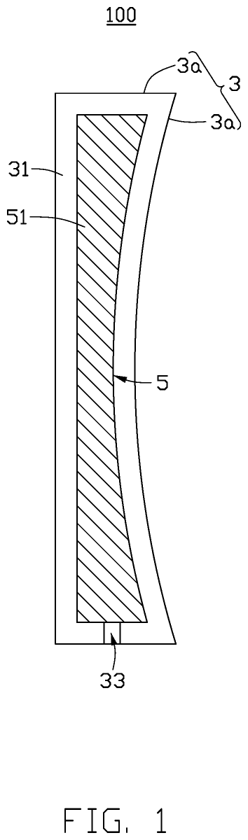

The present disclosure provides a lens. As shown in FIG. 1, the lens 100 includes a housing 3 made of a first medium 31. The housing 3 defines a cavity 5. A second medium 51 having a required refractive index is filled in the cavity 5. The refractive index of the second medium 51 is decided by a user's eye diopter.

The lens 100 has a single one outer shape, but can be matched with different second mediums 51 having different refractive indices to produce lenses with multiple degrees of myopia/hyperopia. Compared to a method of obtaining lenses having multiple degrees of myopia/hyperopia solely by the curvature and thickness the lens, the outer shape of the lens 100 changes less, and the lens 100 has a simpler design and a simpler production process.

In some embodiments, the second medium 51 is replaceable in the cavity 5. That is, for the same housing 3, the second medium 51 can be replaced multiple times. It is possible to change the refractive index of the lens 100 by filling different second mediums 51 in the cavity 5, which is conducive to achieving the problem of adjustable lens 100 degrees under a constant curvature of the lens 100. This can conveniently and quickly improve the efficiency of the actual production process, thereby reducing costs.

The first medium 31 is made of transparent glass or transparent plastic. In this embodiment, the first medium 31 is plastic, such as polytetrafluoroethylene or polycarbonate. This disclosure does not limit specific materials of the first medium 31, as long as the first medium 31 has good transparency and does not undergo chemical reactions with the second medium 51, it is within the scope of this disclosure.

The housing 3 includes several sub-housings 3a connected to each other by an adhesive bonding method or a composite adhesive strip method. The sub-housings 3aencloses the cavity 5. Specifically, the bonding method involves separating two or more sub-housings 3a with a spacing frame filled with desiccant, and sealing them with a double layer of sealant. The bonding method has good stability, adhesion, and penetration resistance, which greatly improves the performance and service life of the housing 3. The composite adhesive strip method is to bond two or more sub-housings 3a with an adhesive strip on both sides to form the cavity 5 with a certain thickness. The adhesive strip used in the adhesive strip method is an elastic material that is easy to form at corners of the glass, making it more flexible when producing special-shaped insulating glass.

The housing 3 has an overall thickness in a range of 1 mm to 30 mm, a diameter in a range of 1 cm to 10 cm. Any sub-housing 3a has a thickness in a range of 0.1 mm to 5 mm. The cavity 5 has an overall thickness in a range of 0.05 mm to 30 mm, a diameter in a range of 1 cm to 10 cm. The overall thickness of the housing 3, the diameter of the housing 3, the thickness of the sub-housing 3a, the overall thickness of the cavity 5, and the diameter of the cavity 5 are determined according to actual needs of the producer, and there are no restrictions in this disclosure.

The housing 3 includes an injection hole 33. The second medium 51 is filled in the cavity 5 by the injection hole 33. The injection hole 33 can be set at any position on the housing 3. In this embodiment, when the cavity 5 is filled with the second medium 51, the injection hole 33 can be closed by bonding with silicone adhesive or polyurethane adhesive (PU). Since the second medium 51 can be replaced multiple times in the same housing 3, the injection hole 33 can be reopened by dissolving silicone adhesive or polyurethane adhesive (PU) by an organic solvent. In addition, the material of the second medium 51 can also be replaced by defining a new injection hole 33.

The second medium 51 may be one selected from polymer, polymer solution, ionic liquid, and hydrogel. The polymer can be any one consisted of polypropylene (PP), polycarbonate (PC), methyl methacrylate (PMMA), and advanced aminoethyl ester polymers (Trivex). The hydrogel is a network of hydrophilic polymer chains. In the embodiment of this disclosure, the hydrogel can be any one or a combination of silicone gel, polyacrylamide, and silicone containing hydrogel. The second medium 51 has good transparency and cannot chemically react with the first medium 31.

The first medium 31 has a refractive index in a range of 1.4 to 1.7. The second medium 51 has a refractive index in a range of 1.4 to 2.0. The higher the refractive index of the first medium 31 and the second medium 51, the stronger an ability to refract the incident light. The higher the refractive index of the first medium 31 and the second medium 51, the thinner the lens 100. That is, when the center thickness of the lens 100 is the same, and the same degree of material is used, the higher the refractive index of the first medium 31 and the second medium 51, the thinner the edge of the lens 100 compared to the lower refractive index of the first medium 31 and the second medium 51. For example, users with mild myopia or mild hyperopia, i.e. those within −2.00 or +2.00, choose the refractive index of the first medium 31 and the second medium 51 to be around 1.5. It is recommended that users within −8.00 or +8.00 choose the refractive index of the first medium 31 and the second medium 51 to be around 1.6.

The higher the refractive index of the first medium 31 and the second medium 51, the more severe the dispersion, and the less the Abbe number. Abbe number is an index represents a dispersion ability of a medium. The higher the Abbe number of the lens, the lower the refractive index, and the higher the transmittance. The less the refractive index and dispersion of the first medium 31 and the second medium 51, the greater the Abbe number. For example, when each of the refractive indices of the first medium 31 and the second medium 51 is 1.49, the Abbe number of the lens 100 is about 56. When the refractive indices of the first medium 31 and the second medium 51 are both 1.56, the Abbe number of the lens 100 is about 36. There is a certain inverse correlation between refractive index and Abbe number. That is, the higher the refractive index, the lower the Abbe number.

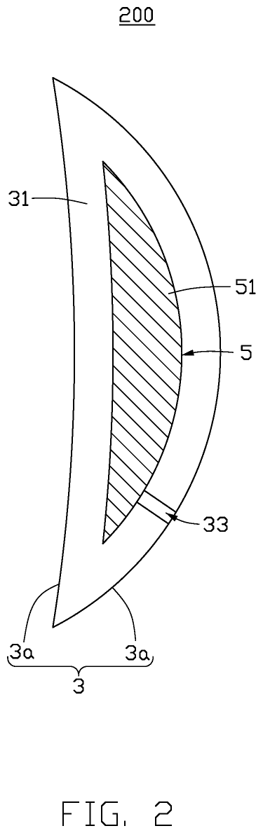

In the first embodiment shown in FIG. 1, the lens 100 is a concave lens, a cross-section of the housing 3 has a shape of a concave lens, and a middle of the cavity 5 (or the second medium 51) is thin and a periphery of the cavity 5 (or the second medium 51) is thick. In the second embodiment shown in FIG. 2, the lens 200 is a convex lens, a cross-section of the housing 3 has a shape of a convex lens, and a middle of the cavity 5 (or the second medium 51) is thick and a periphery of the cavity 5 (or the second medium 51) is thin. Whether the lens 100 is a concave or convex lens depends on whether the user is nearsighted or hyperopia. When the user is nearsighted, compared to normal eyes, the lens of the nearsighted eye is more convex, the focal length is shorter, and objects at a bright distance will be imaged in front of the retina, making the image of the object appear blurry. When wearing the lens 100 with the housing 3 shaped a concave lens, the user can use divergent effect of the concave lens on light to move the object's image back onto the retina. When the user has hyperopia, compared to normal eyes, the lens of the hyperopia eye is flatter, the focal length is longer, and objects at the distance of bright vision will be imaged behind the retina, making the image of the object appear blurry. When wearing a lens 200 with the housing 3 have a convex lens cross-section, the user can use the converging effect of the convex lens on light to move the object's image forward and onto the retina.

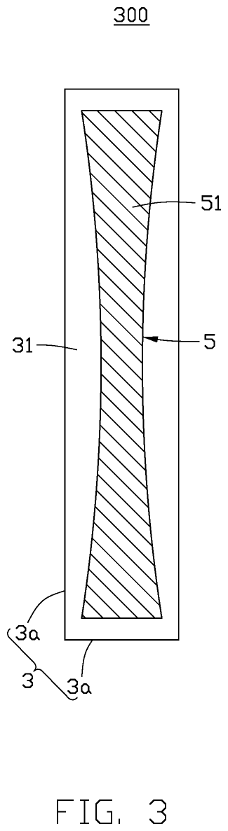

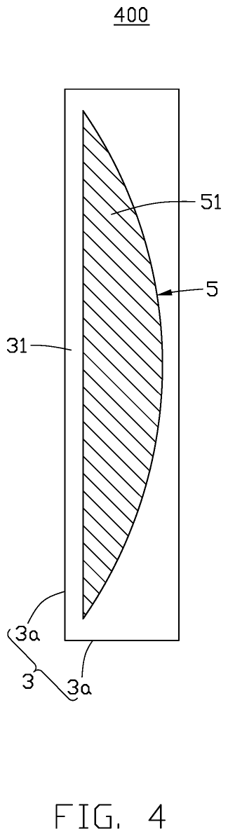

As shown in FIG. 3, the Lens 300 is a flat mirror, and the cross-section of housing 3 is rectangular. The middle of the cavity 5 (or the second medium 51) is thin and the periphery of the cavity 5 (or the second medium 51) is thick, presenting a concave lens shape. When wearing a lens 300 with the housing 3 having a concave cross-section, the user can use divergent effect of the concave lens on light to move the object's image backwards onto the retina. As shown in FIG. 4, in other embodiments, the lens 400 is a flat mirror, the cross-section of the housing 3 is rectangular, and the middle of the cavity 5 (or the second medium 51) is thick and the periphery of the cavity 5 (or the second medium 51) is thin, presenting a shape of a convex lens in FIG. 4. When wearing the lens 400 with the housing 3 having a convex lens cross-section, the user can use converging effect of the convex lens on the light to move the object's image forward and onto the retina. The shape of the housing 3 and the shape of the cavity 5 is determined based on actual function of the applied product, and is not limited.

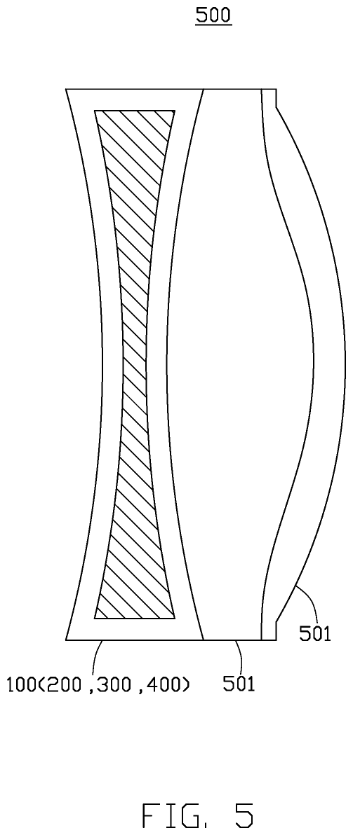

FIG. 5 illustrates a lens group 500. The lens group 500 includes an optical element 501 and one selected from the lens 100, the lens 200, the lens 300, the lens 400 and. The lens 100 (200, 300, 400) is adhered to the optical element 501. The optical element 501 can be at least one of a polarizer, a phase delay films, a Fresnel lenses, an optical waveguide, a grating, and a superlens. The lens group 500 can be used for head mounted display devices, such as augmented reality glasses and virtual reality head mounted display devices. When the lens group 500 is used for augmented reality glasses, the optical element 501 can be any combination of an output coupled grating, an optical waveguide, an input coupled grating, and a free-form surface lens. When the lens group 500 is used for virtual reality head mounted display devices, the optical element 501 can be any combination of a phase delay film, a polarizer, a Fresnel lens, and a superlens. The optical element 501 is determined based on the functionality of the actual product being applied, and is not limited.

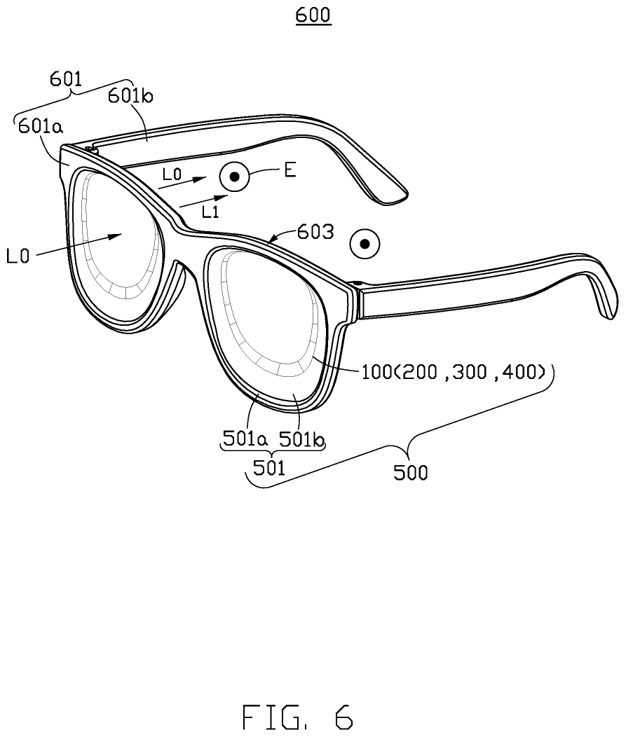

FIG. 6 illustrates a head mounted display device 600. The head mounted display device 600 includes the lens group 500, a first frame 601, and a display module 603. In this embodiment, the head mounted display device 600 is an augmented reality type head mounted display device. The first frame 601 includes a main frame 601a and two legs 601b connecting to the main frame 601a. The first frame 601 is used to fix the lens group 500. At this time, the optical element 501 of the lens group 500 includes an output coupled grating 501a and an optical waveguide 501b. The optical waveguide 501b is used to transmit image light L1. The output coupling grating 501a is used to output the image light L1 transmitted from the optical waveguide 501b. The lens group 500 is used to modulate and transmit the image light L1 to human eye E.

The display module 603 is on the first frame 601. The display module 603 is used to emit image light L1, and the lens 100 (200, 300, 400) can be set on a side far away from the human eye E or near the human eye E of the augmented reality head mounted display device 600. The lens 100 (200, 300, 400) will pass through natural light L0 from real world and fuse the image light L1 with natural light L0 to form an augmented reality image. The natural light L0 passes through the lens 100 (200, 300, 400) and directly enters the human eye E. The display module 603 can be any one of a liquid crystal display, a light-emitting diode display, a miniature light-emitting diode display, an electromechanical laser display, or an organic light-emitting semiconductor display. An optical system part of the augmented reality head mounted display device 600 can be an off-axis reflection optical system, a free surface prism optical system, or a free surface optical waveguide optical system.

The augmented reality type head mounted display device 600 provided in the present embodiment adopts the lens group 500, which allows for the replacement of different filling media to change the refractive index of the lens 100 (200, 300, 400), which is conducive to improving convenience of adhering process of the augmented reality type head mounted display device 600, improving work efficiency of the actual production process, and thus reducing costs.

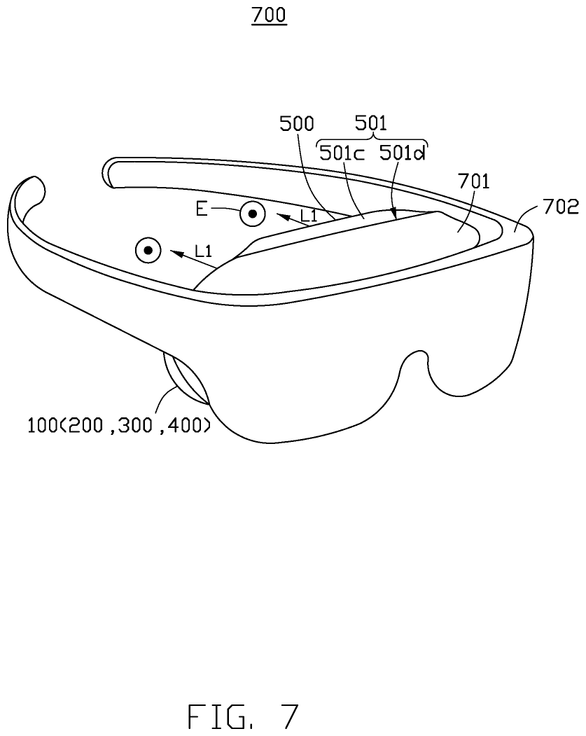

In other embodiments, as shown in FIG. 7, a head mounted display device 700 is a virtual reality type head mounted display device. The head mounted display device 700 includes the lens group 500, a display 701, and a second frame 702. The display 701 is on the second frame 702 and can be located at a top or a side of the lens 100 (200, 300, 400) in the lens group 500. At this time, the optical element 501 of the lens group 500 includes a phase delay plate 501c and a Fresnel lens 501d. The lens 100 (200, 300, 400) in the lens group 500 can be installed on a side far away from the human eye E or near the human eye E of the virtual reality head mounted display device 700. When the user wears the virtual reality head mounted display device 700, the lens 100 (200, 300, 400) in the lens group 300 will pass through the image light L1 from the display 701, the phase delay plate 501c and the Fresnel lens 501d modulate and transmit the image light L1 to the human eye E. The display 701 is used to emit image light L1. The display 701 can be any one of a liquid crystal display, a light-emitting diode display, a miniature light-emitting diode display, an electromechanical laser display, or an organic light-emitting semiconductor display.

The virtual reality type head mounted display device 700 can change the refractive index of the lens 100 (200, 300, 400) by using the lens group 500, which is conducive to improving convenience of the virtual reality type head mounted display device 700 during the adhering process by replacing different filling media.

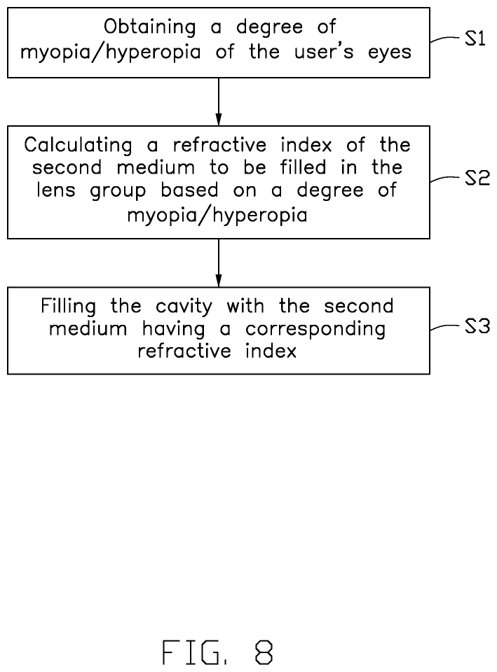

As shown in FIG. 8, the present embodiment also provides a method for adjusting the diopter of the lens group 500. The method includes following step S1 to step S3.

Step S1: obtaining a degree of myopia/hyperopia of the user's eyes.

Step S2: calculating a refractive index of the second medium to be filled in the lens group based on a degree of myopia/hyperopia.

Step S3: filling the cavity with the second medium having a corresponding refractive index.

Specifically, in step S1, the user's degree of myopia/hyperopia can be obtained by an optical optometry instrument. Different second media based on different degrees of myopia/hyperopia of the human eye can be selected, combined with thickness data of the cavity and the housing, and calculate the refractive index of the second medium that needs to be filled in the lens group. In actual production, the lens can be attached to either side of a main body by adjusting the parameters of the optical alignment bonding machine, and then the second medium having a corresponding refractive index can be filled into the cavity by an injection port.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A lens comprising:
a housing made of a first medium, the housing defining a cavity; and
a second medium in the cavity, the second medium having a refractive index,
wherein the second medium is replaceable in the cavity.

2. The lens of claim 1, wherein the first medium has a refractive index in a range of 1.4 to 1.7.

3. The lens of claim 1, wherein the second medium has a refractive index in a range of 1.4 to 2.0.

4. The lens of claim 1, wherein the first medium is made of glass or plastic.

5. The lens of claim 1, wherein the second medium is one selected from polymer, polymer solution, ionic liquid, and hydrogel.

6. The lens of claim 1, wherein the lens is a concave lens or a convex lens.

7. The lens of claim 1, wherein the housing has an overall thickness in a range of 1 mm to 30 mm.

8. The lens of claim 1, wherein the cavity has an overall thickness in a range of 0.05 mm to 30 mm.

9. A lens group comprising:
a lens, the lens comprising:
a housing made of a first medium, the housing defining a cavity; and
a second medium in the cavity, the second medium having a refractive index,
wherein the second medium is replaceable in the cavity; and
an optical element, the lens adhering to the optical element.

10. The lens group of claim 9, wherein the first medium has a refractive index in a range of 1.4 to 1.7.

11. The lens group of claim 9, wherein the second medium has a refractive index in a range of 1.4 to 2.0.

12. The lens group of claim 9, wherein the first medium is made of glass or plastic, the second medium is one selected from polymer, polymer solution, ionic liquid, and hydrogel.

13. The lens group of claim 9, wherein the lens is a concave lens or a convex lens.

14. The lens group of claim 9, wherein the housing has an overall thickness in a range of 1mm to 30 mm, the cavity has an overall thickness in a range of 0.05 mm to 30 mm.

15. The lens group of claim 9, wherein the optical element comprises an output coupled grating and an optical waveguide, the optical waveguide is configured to transmit the image light, the output coupling grating is configured to output the image light transmitted from the optical waveguide.

16. The lens group of claim 9, wherein the optical element comprises a phase delay plate and a Fresnel lens.

17. A head mounted display device comprising:
a frame,
a display module, the display module fixed on the frame, the display module configured to emit image light;
a lens group, the lens group fixed on the frame, the lens group configured to modulate natural light and the image light, the lens group comprising:
a lens, the lens comprising:
a housing made of a first medium, the housing defining a cavity; and
a second medium in the cavity, the second medium having a refractive index,
wherein the second medium is replaceable in the cavity; and
an optical element, the lens adhering to the optical element.

18. The head mounted display device of claim 17, wherein the optical element comprises an output coupled grating and an optical waveguide, the optical waveguide is configured to transmit the image light, the output coupling grating is configured to output the image light transmitted from the optical waveguide.

19. The head mounted display device of claim 17, wherein the optical element comprises a phase delay plate and a Fresnel lens.

20. A method for adjusting a diopter of the lens group of claim 9, the method comprising:
obtaining a degree of myopia/hyperopia of eyes of an user;
calculating a refractive index of the second medium to be filled in the cavity based on the obtained degree of myopia or hyperopia; and
filling the cavity with the second medium having the refractive index.
